(19) United States
(12) Patent Application Publication
(10) Pub. No.: US 2004/0248630 A1
(43) Pub. Date: Dec. 9, 2004

(54) Game play feature for video game

(76) Inventors: Lawrence J. Hodgson, Kildeer, IL (US); James Zielinski, Lake in the Hills, IL (US)

Correspondence Address: WELSH & KATZ, LTD, 120 S RIVERSIDE PLAZA, 22ND FLOOR, CHICAGO, IL, 60606, US

(21) Appl. No.: 10/738,869

(22) Filed: Dec. 17, 2003

Related U.S. Application Data
(60) Provisional application No. 60/435,282, filed on Dec. 23, 2002.

(51) Int. Cl. G06F 17/00

(52) U.S. Cl. 463/3

(57) ABSTRACT

An optional challenge feature is incorporated into a video game. The challenge is intermittently offered to a player with an ongoing play sequence on the respective video machine. The player can accept or decline the challenge. A prize can be awarded for successfully meeting the challenge.

The benefit of a filing date of Dec. 20, 2002 of Provisional Application No. 60/435,282 is hereby claimed.

### FIELD OF THE INVENTION

The invention pertains to video games. More particularly, the invention pertains to games which incorporate a supplemental game play challenge.

### BACKGROUND

Video games present an opportunity for players to participate in various types of game simulations inexpensively and in a relatively comfortable environment without having to actually enter the environment which is being simulated by the game. One popular form of video game is a golf playing game. Golf playing games give players an opportunity to exercise their skill on a simulated course. Other types of sport games, vehicle driving games, hunting, puzzles or carnival games also give players a chance to exercise and/or demonstrate their skills.

As those who have played golf know, it can both be challenging and exciting. The complexity of real or simulated courses can challenge even the most proficient of players. Additionally, the possibility of a hole-in-one under various circumstances adds to the excitement of the game.

It would be desirable to be able to introduce, on an intermittent basis, an ability to present various challenges to game players, such as players of golf, or other games, within the context of normal game play. Adding exciting game features should raise the interest of players in the video game or games which in turn will encourage the players to play the game. This is a particularly desirable result in the context of coin operated arcade-type video games.

### BRIEF DESCRIPTION OF THE DRAWINGS

FIG. 1 is a block diagram of an exemplary implementation of the present invention;

FIG. 2 is a block diagram of a game machine useable with the system of FIG. 1;

FIG. 3 is a screen illustrating an exemplary screen of a golf game presented on the game machine of FIG. 2;

FIG. 3-1 is an exemplary screen offering the player an optional special challenge;

FIG. 3-2 is an exemplary screen of the player P attempting the offered challenge;

FIG. 3-3 is an exemplary screen reflective of the fact that the player P was not successful in executing the challenge;

FIG. 3-4 is an exemplary screen illustrating success by the player P in meeting the offered challenge;

FIG. 3-5 is an exemplary screen seeking additional player identification information as well as prize selection;

FIG. 3-6 is an exemplary player identification confirmation screen;

FIG. 3-7 is an exemplary screen seeking the mailing address of the player P for purposes of delivering the prize;

FIG. 3-8 is an exemplary confirmation screen providing to the player P a receipt indicative of winning the selected prize; and

FIG. 4 is a flow diagram of a method in accordance with the invention.

### DESCRIPTION OF THE PREFERRED EMBODIMENTS

While this invention is susceptible of embodiment in many different forms, there are shown in the drawing and will be described herein in detail specific embodiments thereof with the understanding that the present disclosure is to be considered as an exemplification of the principles of the invention and is not intended to limit the invention to the specific embodiments illustrated.

Systems and methods which embody the present invention expand game play opportunities and present new and exciting challenges to the player(s) of video games, or, game machines. An optional special challenge is intermittently, or more-or-less randomly, presented to the player(s) at a point during normal game play. The player(s) can accept or decline the challenge.

If declined, normal game play continues. If accepted, an alternate play sequence is presented to the player(s). If the player is successful, a prize can be awarded.

The present game play feature can be advantageously incorporated into a variety of video games including video sports related games, puzzle games, vehicular driving games, shooting gallery or hunting games. In each instance, an optional intragame challenge is presented to the respective player, but only occasionally. The player can accept or decline the challenge.

In a disclosed embodiment, the present invention relates to a game play feature that can be used in conjunction with a golf video game. It is suited for credit or coin operated video games.

This game play feature allows players to win prizes by meeting certain challenges presented to them during play of the video game. For instance, in the golf video game, a game player could win a prize by obtaining a hole-in-one, or achieving another similar goal, while playing the video game. The present location of the ball could be anywhere in the Tee-box, rough, fairway or adjacent to or on the green.

Other types of challenges could be presented to the player(s). The present invention is designed to encourage players to play video games, by adding an optional challenge to the game.

During play of the video game, for example on selected golf holes, the player can be asked to make a selection as to whether or not (s)he desires to attempt the challenge of the game play feature of the present invention. The player indicates that (s)he believe(s)he will obtain a hole-in-one on that particular golf hole. In other types of games the challenge would correspond to the nature of the game.

For example, the player is asked to choose from “YES” or “NO” choices. A predetermined prize will then be described to the player. It will be communicated to the player that the player will be awarded the prize, if (s)he achieves successful play of the game play feature by obtaining a hole-in-one on that particular golf hole.

If the player makes the appropriate selection to participate in play of the game play feature, the player will optionally be asked to pay an entry fee for such play. If the player desires to continue, the player will establish a credit for the fee. For example, the play can insert the appropriate amount of money into a money slot in the cabinet of the coin operated arcade machine and/or make payment in another available form, such as through a credit card or another account set up to enable play of the game play feature.

In the disclosed golf game embodiment, the player then continues play of the video game by taking his/her shot from the then current location of the ball. If, on the very next shot, the ball goes into the cup of the selected hole, the player has achieved a hole-in-one. As a result, the player is awarded the previously referenced prize.

The prize can be distributed in any manner available. For instance, if the player wins the prize (s)he might be asked to enter contact information, such as name, address and telephone number so that the prize can be shipped to the winning player. Alternatively, a machine operator can provide the player with the prize immediately. Still further, a certificate for obtaining the awarded prize can be printed and/or sent to the winning player by mail, including electronic mail. In another alternate, an award presentation device could be incorporated into the video game. For example, such device(s) could include without limitation, printers, cash dispensers, magnetic card writers, or the like. Another alternate, a prize confirmation number or code could temporarily be displayed for the player.

Coin operated video games are often owned and operated by a party generally referred to as an operator. To make the game play feature of the present invention more flexible, various operator-controlled settings can be implemented. For example, the operator of the video game could be able to suppress or disable the game play feature of the present invention completely such that the video game does not permit players thereof to select the game play feature. In addition, the operator could choose among various entry fee arrangements and/or prize combinations.

The present game play feature can be configured to operate fully automatically without any need for administrative intervention. Alternately, the game administrator can administer play of the game play feature. In certain instances, the game administrator will be the operator. In other instances, such as in the case where the video game is enabled for tournament play over a broad geographical region via a network, a dedicated game administrator may be available to administer the game play feature.

The game administrator, or an automated process, can be responsible for collection of any entry fees if applicable, sharing entry fees with owners and/or operators of the coin operated game if applicable, fulfillment of any and all prizes, creation and enforcement of rules and regulations for play, and determination of the frequency that the game play feature is offered to players, most preferably on a game by game basis. The game administrator can also be responsible for additional game and feature administrative tasks.

It will be understood that variations are possible relative to the capabilities made available to the operator or the administrator in implementing the optional game play feature on one or more games. All such variations come within the spirit and scope of the invention.

In a disclosed embodiment, game machines enabled with the game play feature of the present invention are optionally, able to communicate with computers operated by the game administrator, via for example a computer network. With this channel of electronic communication, the administrator is able to carry out the administrative tasks for enabling the game play feature for play on select game machines.

In one embodiment, the game administrator can set and change the frequency that the game play feature will be offered to players on a given game machine. Data related to such control can be communicated through this channel of communication. In addition, the eventual outcome of the offer and play of the game play feature can also be communicated through this channel of communication. Moreover, information indicative of whether or not the player elected to participate in play of the game play feature, the outcome of the play of the game play feature, the time of the event, the machine the event took place on, and additional statistical information can be communicated to the game administrator via the communication channel.

In another embodiment, the game administrator and/or the game machine operator can manage the frequency that the game play feature is offered to the players such that the feature remains financially viable for all parties involved. For example, software associated with the video game can determine based on a variety of criteria whether or not the game play feature will be offered to the player. The criteria may include but is not limited to, the time of day, the day of the week, the popularity of the given machine that is being played on, the frequency prizes have been awarded on the other machine, and/or the type or mode of game that was selected to be played. Other decision criteria can be used and come within the spirit and scope of the invention.

In summary, optional game play features, as described above, can be incorporated into video games of skill (electronic golf, basketball, bowling, basketball, puzzles, driving games, shooting gallery or hunting games without limitation). Players can accept or decline the posed challenge(s). Awards or prizes can optionally be presented to successful player(s) on individual machines or networked machines.

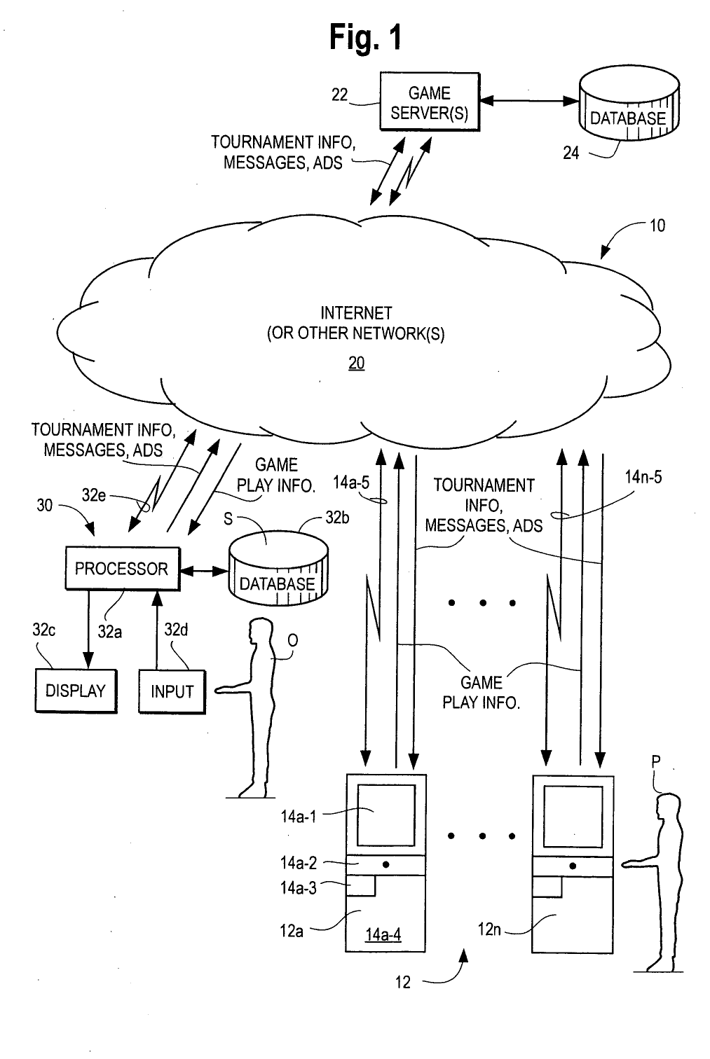

FIG. 1 illustrates a system 10 in accordance with the present invention. The system 10 incorporates a plurality of game machines, which could be substantially the same or could be different, all without limitation, 12a . . . 12n. Each of the machines is designed and intended to enable a player or players P to engage in or play a game of the type provided by such game machines. For example, and without limitation, the game machines 12a . . . n could enable the players P to play various different golf games as well as games with different rules. Alternately, the machines 12a . . . n could enable the players P to play baseball, bowl, safari or hunt. Other types of games of skill such as vehicular racing, shooting galleries and the like come within the scope and spirit of the present invention, and could be played on some or all of the game machines 12a . . . 12n.

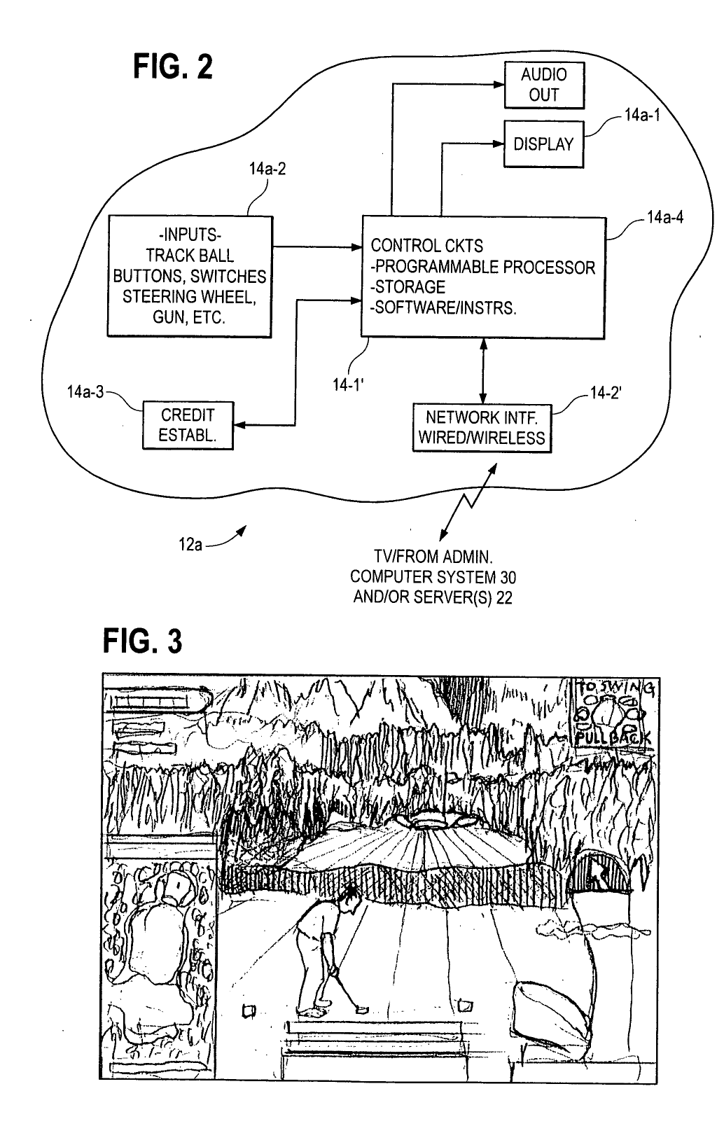

By way of example, see also FIG. 2, the game machine 12a can incorporate a display 14a-1, an operator input interface 14a-2 which might include buttons, switches, track balls, joysticks, steering wheels, guns, or the like, all without limitation.

A credit establishing device 14a-3 could receive coins or credit cards to authorize us and play of the machine 12a. Finally, control circuitry 14a-4 is carried within the housing of the machine 12a and is coupled to the display 14a-1, input panel 14a-2 and credit establishing mechanism 14a-3. The control circuitry 14a-4 can include a programmable digital processor, storage for software 14-1′, executable instructions (both permanently pre-stored, and/or downloadable as desired). The game machine(s) can each include a wired or wireless network interface 14-2′.

One type of game machine usable with the system 10 is the GOLDEN TEE brand electronic golf game(s) marketed by the assignee hereof. Subsequent references to golf, golf courses, tournaments, rules or the like, are exemplary only. They are for the purpose of describing embodiments of the invention so as to enable those of skill in the art to make and use same, and for the purpose of disclosing the best mode of practicing same. They are not limitations of the invention.

The machines 12a . . . n can be intermittently linked, wirelessly, or, via communication channels such as, for example, dial-up telephone lines 14a-5 . . . 14n-5 to a network, such as the internet 20. One or more machines can share a given communication link since none of the members of the plurality 12a . . . n need carry-on continuous communication with the respective link.

The game machines 12a . . . n can initate bi-directional communication, using interface(s) 14-2′ via the internet or other networks 20, with one or more game server(s) 22. The game server(s) 22 support a game-related database 24 which can be periodically updated with information by transmissions initiated via one or more of the game machines 12a . . . n.

The game server(s) 22 can in turn download to the respective game machines 12a . . . 12n information stored in database 24 when the respective game machine communicates with the server(s) 22. It will be understood that communication details between the game machines 12a . . . 12n, network 20 and server(s) 22 are not limitations of the present invention.

It will also be understood that game play information or data from the respective game play machines 12a . . . 12n can be up-loaded to the server(s) 22 and database 24, via wireless or wired network 20.

An operator's or administrator's computer system 30 incorporates a processor 32a, associated with database 32b, display 32c and input devices such as keyboards, touchscreens, track balls, mice and the like 32d, all without limitation. The operator computer system 30 can be placed into intermittent communication via the network 20, over a link 32e with game server 22. In this circumstance, game play information up-loaded from the game machines 12a . . . n stored in database 24 can be downloaded by the link 32e to the operator's computer 30 for local storage in database 32. Once the operator O has obtained the necessary information, he/she can operate off-line to carry out various of the functions.

Player information can be retrieved from server(s) 22. Messages and leaderboards can be sent, via the network 20 directly to online machines 12a . . . n.

Other representative game sequences could include vehicular racing with a multi-path roadway, a baseball game with a batter ready for the next pitch, or any other type of video game without limitation.

Operator or administrator software S executed at processor 32a enables the operator, administrator or owner to create and administer a variety of contests and promotions. If desired, the software tool S could be downloaded from server 22 and stored locally 32b for execution at the operator's convenience. One such system is disclosed in U.S. patent application Ser. No. 10/622,891 filed Sep. 15, 2003, entitled “Data Delivery and Management System and Method for Game Machines”, assigned to the assignee hereof and incorporated by reference.

FIG. 2 is a block diagram of representative game machine 12a housed in cabinet 14-3′. Control software 14-1′, in combination with other elements of game machine 12a present a game play sequence to player P. Player P, via display 14a-1 and input device(s) 14a-2 interacts as appropriate to respond to the game being presented.

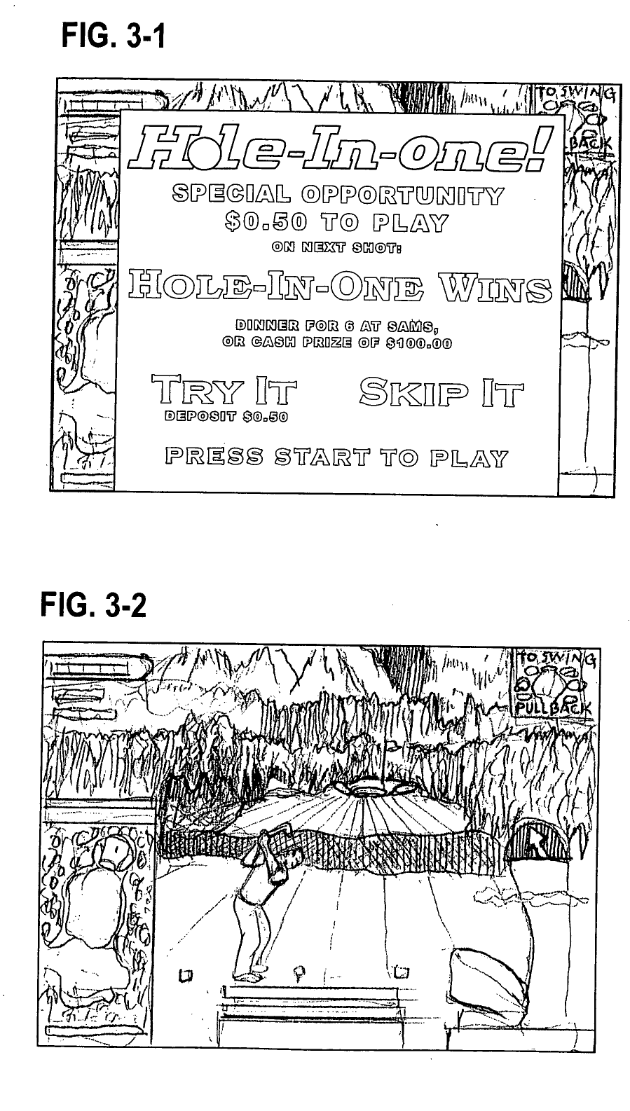

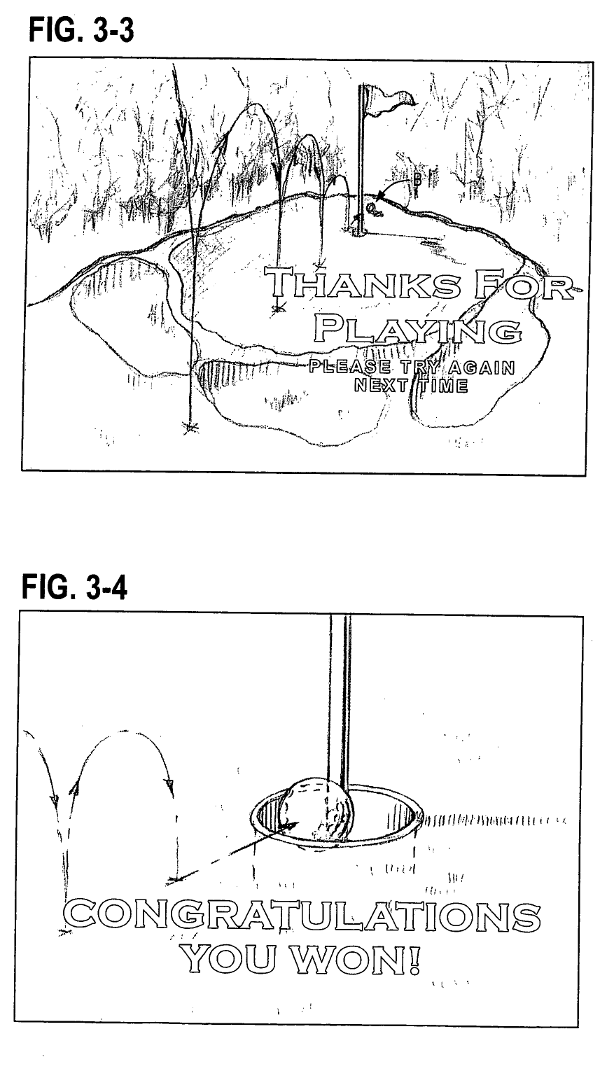

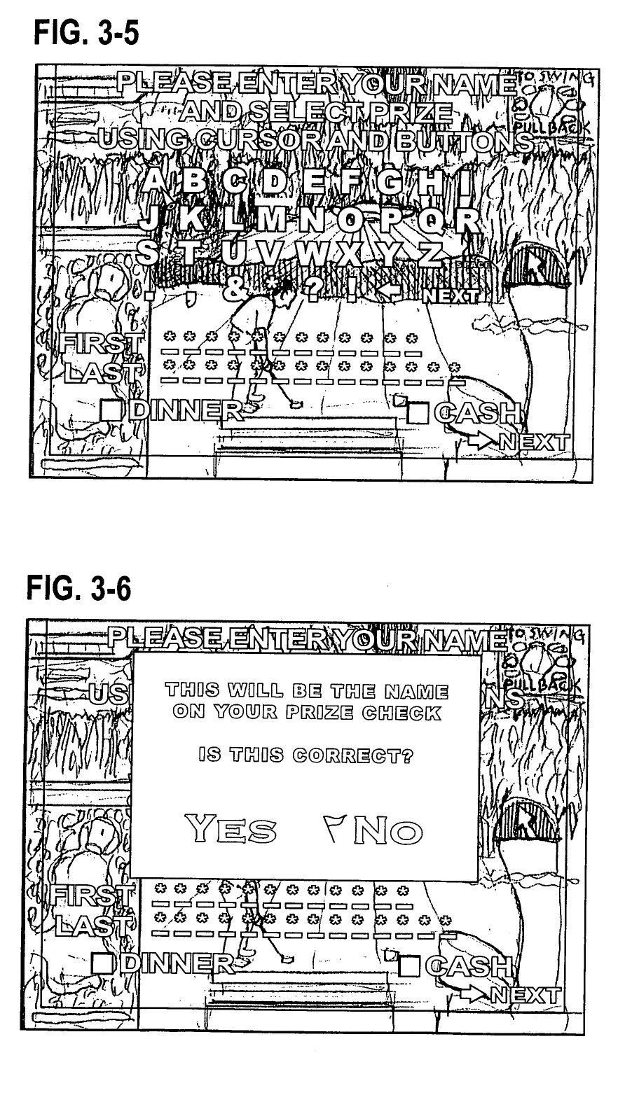

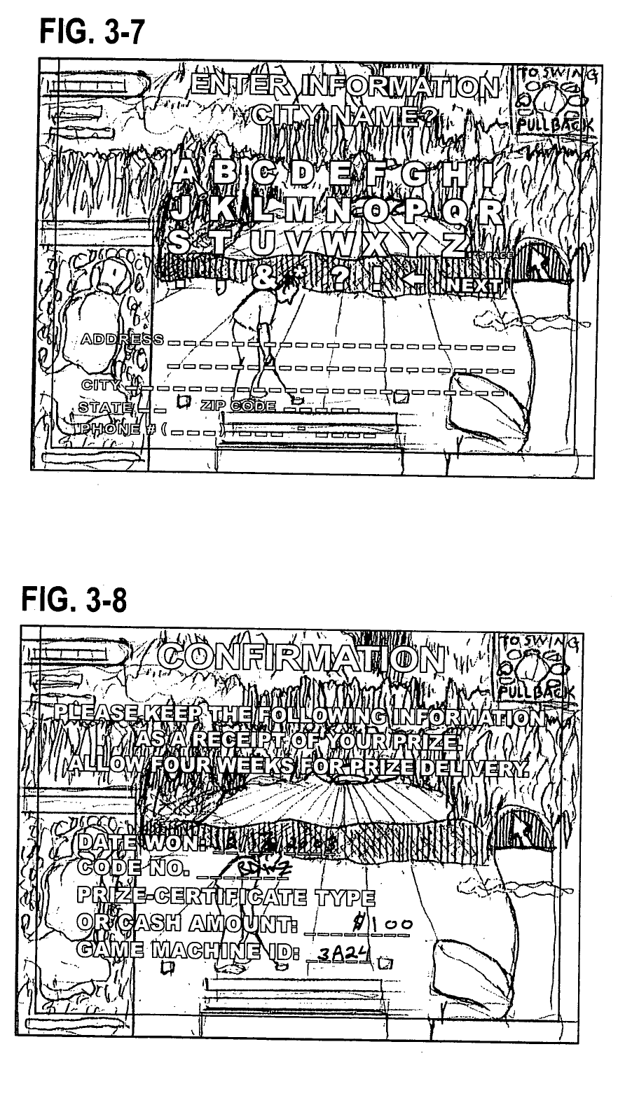

For example, as would be understood by those of skill in the art, for a sports-type game such as golf, a display could be presented on display 14a-1, see FIG. 3, of a golfer ready to make a T-shot. Those of skill in the art will understand that the ball's location is not limited to the Tee-box. It could be on the fairway, in the rough, on or adjacent to the green, all without limitation.

Further, relative to FIG. 3, a golfer G is illustrated preparing to tee off for the next hole in a round of golf. Where control circuits 14a-4, perhaps in conjunction with game server(s) 22, has determined its appropriate to offer an intragame challenge to the player P. The game play sequence is interrupted and a screen, see FIG. 3-1, is presented on display 14a-1 advising player P of an opportunity to attempt to make a hole-in-one on the next shot. The player is offered a choice of one of two possible prizes in the event that he/she makes the hole-in-one.

The player can elect to try for the hole-in-one. At the same time, he/she establishes an optional proper credit using coins or a card, or an existing account, all without limitation. Alternately, the player P can illuminate the “skip it” message to continue with normal play.

If the player elects to “try it”, as illustrated in FIG. 3-2, a tee shot is made in an attempt to achieve the hole-in-one. Where the hole-in-one is not achieved, an appropriate message is presented on display 14a-1 in conjunction with the respective green and the golf ball B, see FIG. 3-3.

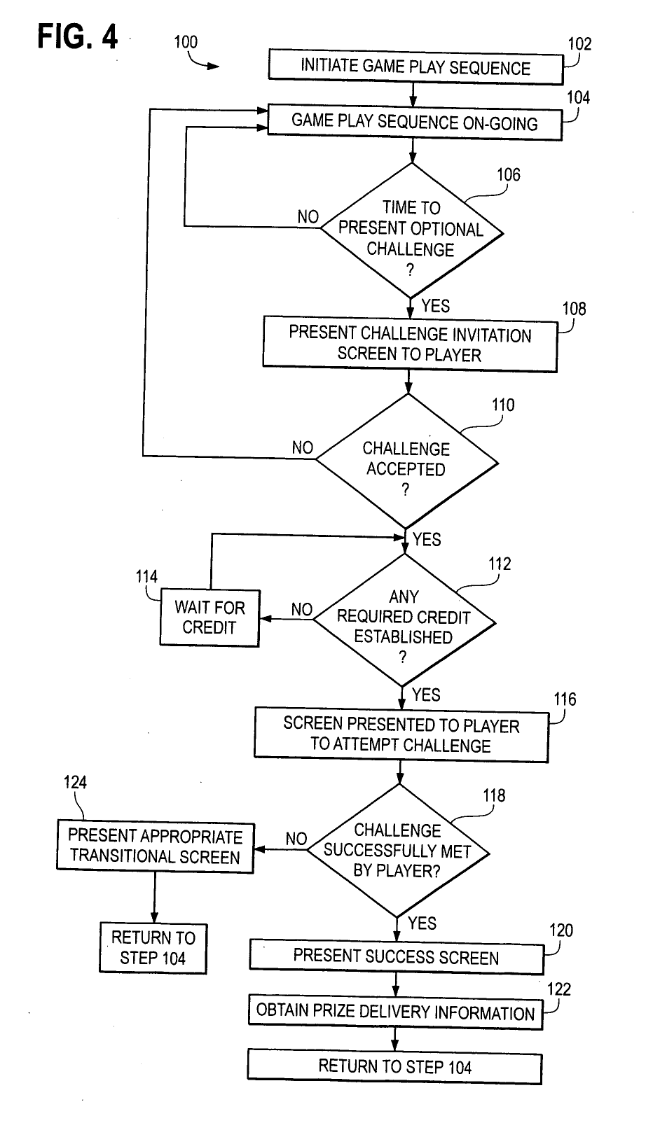

In the event that the player P has made the appropriate shot, the ball B is illustrated in the cup, FIG. 3-4, along with a congratulatory message. FIG. 3-5 is a screen then presented on display 14a-1 to enable the winner to enter his/her name and select the desired prize.

FIG. 3-6 illustrates an overlay on the screen of FIG. 3-5 seeking confirmation from the player P that his/her identification information as well as the prize selection is correct. FIG. 3-7 is a screen enabling the winning player P to enter his/her address. A similar overlay confirmation screen, comparable to the screen illustrated in FIG. 3-6 could be used to confirm the correctness of the address entered in FIG. 3-7. FIG. 3-8 is a feedback confirmation screen presented by control circuits 14a-4 providing information to the winning player P for prize tracking purposes. Subsequent to the presentation of the screen of FIG. 3-8, normal game play resumes at the next hole.

It will be understood that while the optional challenge opportunity has been presented to the player P prior to taking a tee-shot, the message screen of FIG. 3-1 could be presented prior to any other shot, including any shot where the ball B has landed on the fairway or has already landed on the green. In that event, the attempt to meet the challenge would be an attempt to successfully put the ball B into the cup from that respective location. Thus, the optional challenge message of FIG. 3-1 can be used at any point within the golf game play sequence.

FIG. 4 illustrates a flow diagram of a method 100 in accordance with the invention. In a step 102, the game play sequence is initiated, perhaps in response to the player establishing an initial play credit. In a step 104, the usual game play sequence for the respective game is presented to the player with the player interacting as appropriate for the game.

In a step 106, a determination is made as to whether the optional challenge should be presented to the player. If not, the normal game play sequence continues, step 104.

If it is appropriate to present the optional challenge to the player, an invitational screen is presented in a step 108. The player can accept or decline the proffered challenge, step 110. If declined, the game sequence continues step 104.

If the challenge is accepted an optional additional credit can be required to participate in the challenge. In step 112 the presence of the required additional credit is determined. If it has not as yet been established, the credit is awaited, in step 114.

Where the credit if required, has been established, a screen, see FIG. 3-2 is presented to the player to enable the player to attempt the challenge, step 1116. If the challenge has been successfully met by the player, step 118, a “success” screen is presented step 120.

In step 122, prize delivery information is obtained from the player. Subsequent to obtaining the prize delivery information, the game play sequence is continued, step 104.

In the event that the challenge has not been successfully met by the player, a “no win” transitional screen is presented to the player, step 124. The game play sequence then continues, step 104.

It will be understood that the decision to offer the optional challenge, step 106, can be made based on a variety of criteria as would be understood by those of skill in the art. Neither those criteria nor the process of evaluating same are limitations of the invention.

It will also be understood that the above described challenge feature could be implemented in games presented on alternate platforms such as cellular telephones, personal computers or other personal game devices without limitation: Further, it will be understood that the above described challenge feature could be incorporated into games of chance without limitation.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modification as fall with the scope of the claims.

What is claimed is:

1. A game of skill comprising:
game play circuitry coupled to each of a visual output device and at least one player manipulatible input device;
an optional intra game play feature implemented by the game play circuitry, and circuitry for presenting that feature as a game play option to a player on the visual output device; and
circuitry coupled to the input device, for receipt of a player's agreement to execute the game play option.

2. A game as in claim 1 which includes player credit establishing circuitry for receipt of a credit associated with the game play feature.

3. A game as in claim 2 where the game play circuitry, in response to an established player credit, presents the optional play feature to the player.

4. A game as in claim 1 with an award presentation device for presenting an award to the player in response to successfully executing the game play feature.

5. A game as in claim 1 where the game play circuitry implements at least one of a sports game, a puzzle, a hunting game, a vehicle driving game, a carnival game, or other competitive types of games.

6. A game as in claim 1 where the optional intra-game play feature comprises at least one of a hole-in-one contest of a golf playing game, a course variation of a driving game, a special hunt in a hunting game, or, a batting contest in a baseball game.

7. A game as in claim 1 where the game play circuitry comprises software to implement a selected game.

8. A game as in claim 7 where the software, when executed in part implements a golf playing game and an optional hole-in-one contest.

9. A game as in claim 2 where the game play circuitry comprises software executed to, in part, to implement a selected game.

10. A game as in claim 9 where the software implements a game of golf.

11. A game as in claim 10 where the game play feature comprises a hole-in-one.

12. A game as in claim 11 where the software presents an award to the player in response to a successful hole-in-one.

13. A game as in claim 1 where the optional game play feature comprises a variation on the normal play pattern of the game.

14. A game comprising:
first software recorded on a computer readable medium for implementing at least in part, a video game;
second software recorded on a computer readable medium for implementing at least in part, an optional player challenge.

15. A game as in claim 14 where the first software presents an optional hole-in-one contest while a golf game is being played.

16. A game as in claim 15 where the first software requests a credit from the player as a condition precedent to the hole-in-one contest.

17. A game as in claim 15 including software to disable the hole-in-one contest.

18. A game as in claim 14 where the second software provides an award to the player for successfully completing the challenge.

19. A game as in claim 18 which includes further software for communicating via a computer network with another processor.

20. A game as in claim 18 which includes software for interacting with a displaced game administrator.

21. A game as in claim 15 where the second software makes a determination, based at least in part on one of the time of day, day of the week, popularity of a respective game machine, frequency of prior hole-in-one contest award or type of optional hole-in-one contest as to whether a hole-in-one contest will be offered to the player.

22. A game as in claim 14 where the video game comprises one of a game of chance or a game of skill.

23. A game system comprising:
a plurality of video games, the members of the plurality can communicate via a computer network;
at least some members of the plurality each include an optional game play feature which may be offered to a player during a game sequence.

24. A game system as in claim 23 where at least some of the members of the plurality are selected from a class which includes games of skill and games of chance.
